(19) United States
(12) Patent Application Publication
(10) Pub. No.: US 2016/0309759 A1
(43) Pub. Date: Oct. 27, 2016

(54) SYSTEM AND METHOD FOR PRODUCING INDIVIDUALLY-WRAPPED PEANUT BUTTER AND OTHER NUT PRODUCTS

(71) Applicant: The Board of Regents for Oklahoma State University, Stillwater, OK (US)

(72) Inventors: William George McGlynn, Stillwater, OK (US); Danielle D. Bellmer, Stillwater, OK (US); Adrian Michelle Nault, Enid, OK (US)

(21) Appl. No.: 15/185,981

(22) Filed: Jun. 17, 2016

Related U.S. Application Data
(63) Continuation-in-part of application No. 15/103,670, filed on Jun. 10, 2016.
(60) Provisional application No. 61/915,372, filed on Dec. 12, 2013.

(51) Int. Cl. A23C 9/12

(52) U.S. Cl. CPC A23L 25/30; A23L 25/10; A23V 2002/00

(57) ABSTRACT

There is disclosed herein an embodiment of the invention that comprises a formulation of peanut butter, transglutaminase (TG), and other functional ingredients formulated and manufactured in such a way as to create a product that is capable of being formed into an individually-wrapped slice of a segment (square or other shape) with the appearance and sensory characteristics of traditional peanut butter. Specifically, the functional ingredients may include peanut butter, transglutaminase, mono- and diglycerides, and gum. Vegetable protein concentrate may also be added as well as water, sugar, vegetable fat, and peanut flour.

### CROSS REFERENCE TO RELATED APPLICATIONS

This application claims the benefit of expired U.S. Provisional Patent Application Ser. No. 61/915,372 filed on Dec. 12, 2013, and PCT application No. PCT/US2014/070171, filed Dec. 12, 2014, and is a continuation-in-part of co-pending U.S. patent application Ser. No. 15/103,670, filed Jun. 10, 2016, and incorporates said applications by reference into this document as if fully set out at this point.

### FIELD OF THE INVENTION

The present invention relates generally to the field of food production and, more particularly, to production of moldable, formable peanut butter and other nut products such as bites or slices.

### BACKGROUND OF THE INVENTION

In the United States, peanut butter is most commonly used as a spreadable paste on sandwiches. More recently, consumers have discovered that the lunchtime favorite is also excellent in stews, sauces, stir-fries, salad dressings, and in baked goods. Beyond the traditional uses, innovative recipes (formulations) with peanut butter are being created around the world today. A good example of an innovative peanut butter product is the peanut butter slice.

Peanut butter is generally packaged and sold in jars or other rigid containers. Most peanut butter is consumed with bread, usually in the preparation of sandwiches and the like. Removal of the peanut butter from these containers can be inconvenient, requiring the use of a knife or other appropriate utensil. It has been proposed to formulate a solidified peanut butter for the purpose of increasing its convenience. A number of sliced peanut butter products have been formulated over the years but all of them suffered from problems of some sort. For example, a sliced peanut butter product comprised of peanut butter and beeswax was produced in 1941. In 1962, a shape-retaining peanut spread product was disclosed that was spreadable across a broad range of temperatures. It consisted of a mixture of oils, peanut butter, honey, salt, and skimmed milk. A method of making peanut butter in slice form based on a mixture of peanut butter and mono-and-diglycerides was disclosed in 1973. In 2000 an approach was disclosed that discussed a number of different ingredients such as gums, starches, wax, water, oil, and peanut butter. Various formulations and processing procedures were attempted by combining these ingredients with peanut butter all with less than desired results.

There are a number of issues associated with producing a sliced peanut butter product. For example, the formulation must be stable and have an acceptable shelf life when placed within a plastic wrap as this is the way it is most likely to be manufactured and sold to the public. Even if the mixture is stable, it is often problematic to keep the mixture from sticking to the plastic that encloses it since peanuts have a high oil content with might be around 44%. Of paramount concern, though, is making the slices stable while keeping them soft and flavorsome when masticated.

Prior art products have typically required some sort of refrigeration in order to maintain their quality. Because of this, a sliced peanut butter product would have to be sold in grocery stores in the refrigerated section such as adjacent to cheese slices. However, it would be preferable to have the product be shelf stable at room temperature such that it could be sold on shelves adjacent to regular peanut butter. In addition, prior art approaches have had issues with production and consistent quality parameters such as stickiness and peelability. Heretofore, as is well known in the foods industry, there has been a need for an invention to address and solve the above-described problems. Accordingly it should now be recognized, as was recognized by the present inventors, that there exists, and has existed for some time, a very real need for a system and method that would address and solve the above-described problems.

Before proceeding to a description of the present invention, however, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of the invention within the ambit of the appended claims.

### SUMMARY

An embodiment of the invention comprises a formulation of peanut or other nut butter, TG, and other functional ingredients formulated and manufactured in such a way as to create a product that is presented to the consumer as an individually-wrappable slice or wrapped or unwrapped bite-sized portions with the appearance and sensory characteristics of traditional grocery obtained peanut or other nut butter packaged in a jar or other such known container.

Transglutaminase (TG) is a naturally occurring enzyme that causes covalent bonds to form between the ε-amino group of a lysine residue and the Y-carboxamide group of a glutamine residue. An embodiment of a sliced peanut butter product formulated with TG was evaluated based on its textural properties. One version of the inventive product was made by mixing peanut butter with various added ingredients including TG, molding slices in a form, and wrapping them with a plastic film for storage. Sensory evaluation was also performed, evaluating four competing formulations in terms of appearance, texture, flavor and overall acceptability using a 9-point hedonic rating scale. The cross-linking activity bonded and modified the texture of the sliced peanut butter product of an embodiment.

A suitable composition of the present disclosure may include 72-95 weight percent peanut butter, 0.20 to 3 weight percent TG, 0.2 to 10 weight percent mono- & di-glycerides, 0.5 to 8 weight percent vegetable protein concentrate and 0.02 to 1 weight percent gellan gum. Other ingredients could include 0 to 4 percent by weight water; 0 to 5 percent by weight vegetable fat; 0 to 12 percent by weight sugar, 0 to 8 percent by weight peanut flour. A suitable method for producing individually wrapped slices of peanut butter according to the present disclosure may include the steps of supplying a wrapping film; delivering into the wrapping film a composition comprising 72-95 weight percent peanut butter, 0.20 to 3 weight percent TG, 0.2 to 10 weight percent mono- & di-glycerides, and 0.02 to 1 weight percent gum; flattening the composition in the wrapping film; forming individual segments of the composition; individually sealing the individual segments of the composition in the wrapping film.

According to another embodiments, there is provided a composition substantially as described above, but wherein instead of peanuts, cashews or almonds are used. In connection with this particular embodiment, a satisfactory weight composition would be, for example, 72-95 weight percent cashew or almond paste, 0.20 to 3 weight percent TG, 0.2 to 10 weight percent mono- & di-glycerides, 0.5 to 8 weight percent vegetable protein concentrate and 0.02 to 1 weight percent gellan gum. Other ingredients could include 0 to 4 percent by weight water; 0 to 5 percent by weight vegetable fat; 0 to 12 percent by weight sugar, 0 to 8 percent by weight peanut flour.

According to still another embodiment, there is provided composition that comprises a sliceable hazelnut product. In connection with this particular embodiment, a satisfactory weight composition would be, for example, 45 to 80 weight percent hazelnut paste, 2 to 20 weight percent pea protein concentrate, 0.2 to 15 weight percent mono & di-glyceride blend, 0.2 to 15 weight percent cocoa butter, 0 to 20 weight percent sugar, 0.2 to 3 weight percent transglutaminase enzyme, 0 to 3 weight percent lechithin, and 0.02 to 2 weight percent gellan gum, and 0 to 6 weight percent water.

The foregoing has outlined in broad terms the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Further, it should be understood that the phraseology and terminology employed herein are for the purpose of description and should not be regarded as limiting, unless the specification specifically so limits the invention.

### DETAILED DESCRIPTION

### Conventional Peanut Butter Processing

By way of general description, harvested peanuts are cleaned, shelled, and graded for size before being made into peanut butter. Shelling consists of removing the shell (or hull) of peanuts with the least damage to the seed or kernels. Next, peanuts are typically dry roasted either by the batch or continuous method. In the batch method, natural gas-fired revolving ovens rotate, thereby stirring peanuts to produce an even roast. Peanut temperature is raised to approximately 160° C. (320° F.) for 40 to 60 minutes with oven temperatures around 430° C. (800° F.). In the continuous method peanuts are fed from the hopper, roasted in a continuous, pass-through oven, cooled, then ground into peanut butter and stabilized in one operation. The latter method reduces labor, ensures a steady flow of peanuts for other processes, and decreases spillage.

Cooling typically occurs in cooling boxes or on conveyors where large quantities of air are blown over the peanuts immediately following roasting. The next step, blanching, removes the skin of the peanut as well as dust, molds, and other foreign material. There are several blanching (skin removal) methods including dry, water, spin, and air impact, that might be used. Next, the blanched peanuts are pulverized and ground with salt, dextrose, and hydrogenated oil stabilizer in a grinding machine. The stabilized peanut butter is cooled in this rotating refrigerated cylinder (called a votator), from 170 to 120° F. (76.6 to 48.8° C.) or less before it is packaged, stored, and shipped.

Protein Profile

Histidine, isoleucine, lysine, leucine, methionine, phenylalanine, threonine, tryptophan and valine are the nine essential amino acids. Peanut butter is rich in leucine and phenylalanine, containing roughly 0.5 g and 0.4 g per 2 tablespoons. The table below is a breakdown of the amino acids in peanut butter, smooth style, with salt.

TABLE 1
Breakdown of the Amino Acids in Peanut
Butter, Smooth Style, With Salt

| | | 1 Value | 1 cup | 2 tbsp. |
|---|---|---|---|---|
| Nutrient | Unit | per 100.0 g | (258 g) | (32 g) |
| Tryptophan | g | 0.227 | 0.586 | 0.073 |
| Threonine | g | 0.515 | 1.329 | 0.165 |
| Isoleucine | g | 0.605 | 1.561 | 0.194 |
| Leucine | g | 1.518 | 3.916 | 0.486 |
| Lysine | g | 0.669 | 1.726 | 0.214 |
| Methionine | g | 0.261 | 0.673 | 0.084 |
| Cystine | g | 0.225 | 0.580 | 0.072 |
| Phenylalanine | g | 1.180 | 3.044 | 0.378 |
| Tyrosine | g | 0.814 | 2.100 | 0.260 |
| Valine | g | 0.768 | 1.981 | 0.246 |
| Arginine | g | 2.719 | 7.015 | 0.870 |
| Histidine | g | 0.547 | 1.411 | 0.175 |
| Alanine | g | 0.899 | 2.319 | 0.288 |
| Aspartic acid | g | 2.999 | 7.737 | 0.960 |
| Glutamic acid | g | 5.001 | 12.903 | 1.600 |
| Glycine | g | 1.411 | 3.640 | 0.452 |
| Proline | g | 1.383 | 3.568 | 0.443 |
| Serine | g | 1.455 | 3.754 | 0.466 |

Composition

In addition to being a good source of protein, peanuts are also a good source of fiber. Specifically, seven grams of protein and a little more than two grams of fiber are provided with a one ounce serving of peanut butter. Notably, peanut protein has different nutritional properties from animal protein because the protein in peanuts has a different amino acid profile. Peanuts are also a good source of bioactive compounds that may have health-promoting effects. One such compound is arginine, an amino acid that may promote heart health among other benefits. Another bioactive compound found in the roots, the skins and even the shell of peanuts is resveratrol. It has antioxidant properties that can help reduce cardiovascular disease, cancer and inflammation. Peanuts are complex plant foods with high levels of niacin, folate, potassium, magnesium, phytosterols and flavonoids. Peanuts are also rich in leucine and phenylalanine, two of the nine essential amino acids.

For the purpose of the present disclosure, the term “peanut butter” shall include a composition as set forth in 21 C.F.R. §164.150 which may have some or all of the above amino acids, be made as described above, with the above composition, and may include the below-described components.

### EMBODIMENTS

According to an embodiment, Transglutaminase (TG), an enzyme commonly known as meat glue, is used to produce a peanut butter product. TG is an enzyme that catalyzes acyl-transfer reactions between Y-carboxyamide groups of glutamine residues and the 6-amino group of lysines in proteins, which leads to inter- or intramolecular cross-linking. It is believed that any protein containing a sufficient level of glutamine and lysine may be successfully acted upon by TG, thereby forming covalent bonds both externally (between proteins) as well as internally (within the same protein). Previous work has demonstrated such crosslinking is possible in reactions with peanut protein substrates, peanut flour, soy, myosin, gluten, oat globulin, casein, and whey proteins. An embodiment of the instant invention utilizes TG as an ingredient to promote favorable textural qualities by cross-linking activity in a sliced peanut butter product. TG forms bonds with the peanut butter's proteins that allow it to be made into sheets and cut into segments.

In an embodiment, various of the following ingredients and additives were used to produce the inventive sliced peanut butter:

Transglutaminase (TG)

One novel ingredient chosen for use in the product of the present disclosure was Transglutaminase (TG), an enzyme commonly known as meat glue. From microorganisms to mammals, TG is found throughout nature. Although very different in composition, texture and sensory attributes, the use of TG was demonstrated when Wylie Dufresne at Harvard showed his students that noodles could be made from peanut butter.

TG forms bonds with the peanut butter's proteins that allows it to be made into sheets and cut into segments of any desired geometry, most commonly square. If the product does not naturally contain glutamine and lysine, addition of this component helps ensure that it can still be “glued”. Infusion of gelatin-rich water must be performed to help proteins stick together. TG's functions in food processing include: increasing gel strength, providing food bonding, and modifying protein property.

Ajinomoto North America, Inc. is one of the major TG producers under the trademark ACTIVA®. In one embodiment, TG was utilized as an additive to modify the textural properties of the sliced peanut butter product with minimal use of other ingredients and additives.

TG has known potential application in most food systems which contain animal protein. The present disclosure utilizes TG as an additive to peanut proteins. Current ACTIVA® preparations have been specifically designed for the following applications:
ACTIVA® GS: This product is a TG preparation which is innovative in bonding relatively large food pieces, such as large red meat cuts or salmon fillets. It has improved bonding strength and wider handling window when compared to other ACTIVA® bonding preparations. The main components of this preparation are gelatin, phosphate, and TG.
ACTIVA® RM: Specifically designed for restructuring muscle foods such as red meat, poultry and seafood, this form has application in other food products that have a lower protein content. The main components of the preparation are sodium caseinate, maltodextrin, and TG.
ACTIVA® TI: This TG preparation was designed to improve the general texture of products in systems which contain sufficient protein for activity. The central components of the preparation are maltodextrin and TG.
ACTIVA® YG: This TG preparation is unique in that it is designed specifically for dairy applications. This is a patented combination of ingredients that allow an enhanced enzyme activity in more difficult dairy conditions. The central components in this preparation are maltodextrin, lactose, yeast extract and TG.
   Note that for purposes of the instant disclosure, the term “TG” will be interpreted to include any or all of the above TG variants and any other TG source.

Gums

Gums are a group of complex hydrophilic carbohydrates containing thousands of monosaccharide units. Not only because of their affinity for water and their size, but also due to their ability to form stable aqueous colloidal dispersions or solutions, they are often referred to as hydrocolloids. Most gums are unable to form gels due to being highly branched molecules, but they are able to trap or bind large amounts of water within those branches. Because it is difficult for the molecules to move around freely without becoming entangled with each other, aqueous dispersions therefore tend to be very viscous. The categories of gums include: seed gums (guar, locust bean), plant exudates (arabic, tragacanth), microbial exudates (xanthan, gellan, dextran), seaweed extracts (alginates, carrageenan, agar), and synthetic gums (cellulose). Agar gum, gellan gum, and tragacanth gum have been used in the embodiments of the present disclosure. One most preferred embodiment of the present disclosure utilizes gellan gum, which is produced using fermentation by microorganisms. At a concentration as little as 0.05% gum (99.95% water), gellan is capable of forming a gel. Gellan gum is used in the embodiments of the present disclosure to provide gelling, texturizing, stabilizing, suspending, film-forming and structuring to the compositions described herein. That being said, although gellan gum is preferred in some embodiments, other types of gum might also be used.

Acylglycerols

Monoglycerides and diglycerides are commonly used as emulsifiers in a variety of foods. A glycerol molecule with only one fatty acid attached is a monoglyceride, whereas a diglyceride is a glycerol with two fatty acids attached. Since they attract and repel water they are considered hydrophilic and hydrophobic, making them partially soluble in water and in fat. This makes them effective emulsifying agents in the compositions of the present disclosure.

One commonly-used mono- and diglyceride blend currently available for commercial use is sold under the trade name Alphadim®. This blend provides structure and exceptional mouthfeel in food products. Also, it is capable of being incorporated into foods at ambient temperatures and can provide benefits to manufacturing as a processing aid. Alphadim® 90 (i.e., 90% monoglyceride) is useful in some embodiments of the present disclosure.

According to one embodiment, the following table contains a specific example of the percentage by weight of ingredients that was used to make a suitable individually-wrapped peanut butter slice product of the present disclosure:

TABLE 2
Percentage by Weight of Ingredients added in
Peanut Butter Slice Formulation in an embodiment

| Ingredient | Weight Percent |
|---|---|
| Peanut Butter | ~95.0 |
| Gellan Gum | 0.042 |
| Water | 2.09 |
| Mono- & diglycerides | 2.09 |
| TG | 0.75-1.0 |

More generally, Table 3 contains some ingredient ranges that might be used according to various embodiments of the peanut butter product of the present disclosure.

TABLE 3
Percentage Ranges by Weight of Ingredients added in Peanut
Butter Formulation According to a First Embodiment

| Ingredient | Minimum % | Maximum % |
|---|---|---|
| Peanut Butter | 72 | 95 |
| Peanut Flour | 0 | 8 |
| Vegetable protein concentrate | 0.5 | 8 |
| Mono- & diglycerides | 0.20 | 10 |
| Water | 1 | 4 |
| Sugar | 0 | 12 |
| TG | 0.20 | 3 |
| Vegetable Fat | 0 | 5 |
| Gellan gum | 0.02 | 1 |

With respect to the forgoing, it should be noted that key functional ingredients include peanut butter, transglutaminase (TG), mono- and diglycerides, and (gellan) gum. Other ingredients that might be added according to some embodiments are vegetable protein concentrate and some amount of vegetable fat. Vegetable protein concentrate is available in many forms including pea and soy protein concentrate. The vegetable fat constituent improves flavor, but does not affect the functionality of the formulation.

Table 4 contains some ingredient ranges that might be used according to a second embodiment. Note that one difference as compared with the foregoing table 3 is that some amount of one or more of the ingredients peanut flour, vegetable protein concentrate, sugar, and vegetable fat may be included in the mixture.

TABLE 4
Percentage Ranges by Weight of Ingredients added in Peanut Butter
Formulation According to a Second Embodiment

| Ingredient | Minimum % | Maximum % |
|---|---|---|
| Peanut Butter | 72 | 82 |
| Peanut Flour | >0 | 8 |
| Vegetable protein concentrate | >0 | 8 |
| Mono- & diglycerides | 0.20 | 10 |
| Water | 1 | 4 |
| Sugar | >0 | 12 |
| TG | 0.20 | 3 |
| Vegetable Fat | >0 | 5 |
| Gellan gum | 0.02 | 1 |

### Product Preparation Method

The sugar (if desired) and gellan gum is/are added to water that has been heated to 85-90° C. With the use of a high-shear mixer, the gum is mixed to homogeneity. The mono- and diglycerides are then separately melted, and the peanut butter, peanut flour, vegetable protein concentrate, and vegetable fat ingredients are added and mixed until a molten mixture is obtained. The gum/sugar/water homogenate is then added to the molten peanut butter mixture using a high-shear mixer to ensure homogenization. Once the molten mixture cools to 45-55° C., the TG is added. After all of the ingredients have been mixed, they are shaped and formed as desired for packaging.

In all formulations the slices can be formed by at least one of two ways. On a small scale, the molten mixture may be poured into shaped forms or molds, where, after cooling, the product is removed and may be packaged or otherwise further processed. It is preferred, however, and in fact was an object of the present invention, that the inventive compositions be readily subject to large scale industrial production, and, to this end, the molten final mixture is of such a consistency that it can be extruded onto a continuous belt for individual wrapping and packaging by equipment conventionally used in the production of individually-wrapped cheese slices. This type of equipment is well known in the art and typically consists of a series of belts and heated rollers for packaging the slices and heat-sealing them individually. U.S. Pat. No. 2,759,308, incorporated herein by reference, provides a description of an acceptable processing apparatus.

Because of their high peanut butter content, the preferred inventive compositions achieve a flavorful peanut taste. The formulations also result in a product of a very different texture and consistency than prior formulations, both during processing and in its final state. It is particularly preferred that the slices be individually wrapped and in the shape of a square slice, easily removed from the wrapper and thus more convenient than spreading from a jar. To this end, the consistency of the molten final mixture is such that individually-wrapped peanut butter slices can be produced in the same standard equipment used for making individually-wrapped cheese slices. In addition, the compositions and process described herein result in a final product with improved shelf stability. The texture of the product is such that it will hold its shape during normal storage and handling conditions, but is soft when eaten. The added ingredients do not produce any off-flavor or color.

Sensory testing results have demonstrated that the use of TG to cross-link proteins in peanut butter gave the PB Slice product favorable sensory attributes. When it comes to selecting one of these formulations and ingredient range variations over another, other considerations apart from sensory acceptability may be taken into account. For example, one way to select a desired formulation might be to compare the prices of each enzyme. It would be more cost effective to choose the least expensive TG preparation given that each seems to offer acceptable flavor and texture. Other considerations might include the caloric content of the final product which may affect the selection of specific ingredients.

### Sensory Analysis

The means separation tests performed for each sensory attribute—appearance, texture, flavor, and overall acceptability showed that no statistically significance differences were observed in any sample attributes for the different formulations tested. A summary of these results is shown in Table 5, which reports the mean scores and ANOVA results for the acceptability of appearance, texture, flavor, and overall acceptability of sliced peanut butter samples.

TABLE 5
Means, standard deviations and analysis of variance for
sensory attributes of four peanut butter slice samples

| | PB Slice Treatments | | | | |
|---|---|---|---|---|---|
| Attributes | 1.0 TI | .75 RMTI | .75 GS | .75 RM | Pr > F |
| Appearance | 6.9 ± (1.1) | 7.1 ± (1.2) | 7.0 ± (1.2) | 6.8 ± (1.5) | 0.514 |
| Texture | 6.8 ± (1.2) | 6.8 ± (1.4) | 6.8 ± (1.4) | 6.8 ± (1.3) | 0.9392 |
| Flavor | 6.8 ± (1.2) | 6.8 ± (1.3) | 6.9 ± (1.5) | 7.0 ± (1.2) | 0.8804 |
| Overall | 6.9 ± (1.0) | 6.8 ± (1.3) | 6.9 ± (1.3) | 6.9 ± (1.3) | 0.958 |
| Acceptability | | | | | |

When panelists were asked to rate the appearance of the 1.0 TI samples, the majority (21 panelists) moderately liked them. As for their attitudes on the texture of the 1.0 TI samples, most of the panelists (32 panelists) either moderately or very much liked them. The panelist's views on the flavor attribute of 1.0 TI was generally the same; most (48) panelists were on the higher end of the hedonic scale (6-9). Generally, almost all of the panelists liked the overall acceptability of the 1.0 TI samples.

When panelists were asked to rate the appearance of the 0.75 RMTI samples, the majority (45) of panelists gave a response on the higher end of the hedonic scale (6-9), indicating an overall liking of the sample appearance. As for their attitudes on the texture of the 0.75 RMTI samples, most of them (43 panelists) liked them, but 6 panelists disliked the texture and 2 panelists neither disliked nor liked the texture. The panelist's views on the flavor attribute of 0.75 RMTI was generally the same; most (42) panelists gave responses on the higher end of the hedonic scale (6-9). On the other hand, 3 panelists slightly disliked the flavor and 6 panelists neither disliked nor liked the flavor. Generally, almost all of the panelists liked the overall acceptability of the 0.75 RMTI samples. Only 4 panelists slightly did not like the overall acceptability of the 0.75 RMTI samples.

The majority (31) of panelists either moderately liked or very much liked the appearance of the 0.75 GS samples. Even though 5 panelists slightly disliked the texture of these samples, the majority (44) rated the texture with a score higher on the hedonic scale (6-9). As for flavor, 8 panelists either moderately or slightly disliked the flavor of these samples. Alternatively, 44 panelists gave liking responses on the higher end of the hedonic scale (6-9). The overall acceptability of these samples was rated in a similar way; most panelists liked them.

The rating for the 0.75 RM samples were not much different than those of the others. Only 5 panelists slightly or moderately disliked the appearance of these samples, where the majority (42 panelists) liked the appearance. Similarly with texture, few (6) panelists had a slight disliking. The majority of panelists (44) liked the texture of these samples. Flavor ratings were similar to those of texture. The majority (46) of panelists generally liked the flavor. Only 4 panelists either slightly or moderately disliked the flavor of these samples. As for overall acceptability, panelists generally had a liking, but a few (5) did not.

Overall, the use of TG improves the peanut butter slice formulation according to the present disclosure and has resulted in the creation of acceptable product with a shelf-life of up to six (6) months or more.

Of course, many modifications and extensions could be made to the instant invention by those of ordinary skill in the art. As specific examples and according to another embodiment, there is provided a cashew or almond formulation that is sliceable and has a composition substantially as described above in connection with the sliceable peanut embodiment. More specifically, a satisfactory weight composition for this embodiment would be 72-95 weight percent cashew or almond paste, 0.20 to 3 weight percent TG, 0.2 to 10 weight percent mono- & di-glycerides, 0.5 to 8 weight percent vegetable protein concentrate and 0.02 to 1 weight percent gellan gum. Other ingredients could include 0 to 4 percent by weight water; 0 to 5 percent by weight vegetable fat; 0 to 12 percent by weight sugar, 0 to 8 percent by weight peanut flour. Other nuts varieties that would be suitable for use according to the previous approach include pistachios, walnuts, pecans, etc. Those of ordinary skill in the art will understand how the amount of TG and the other constituents might need to be varied depending on the nut type and the desired taste/texture.

As such, and for purposes of the instant disclosure and the claims that follow, the term “nut paste” will be used to refer to peanut butter/paste, cashew butter/paste, or almond butter or paste. Additional nuts that should be included in this definition for “nut paste” include includes butters or pastes formed from pistachios, walnuts, and pecans. Additionally, the terms “butter” and “paste” will be taken to be synonymous for purposes of the instant disclosure

Turning to another embodiment, there is provided sliceable hazelnut product composition that comprises a sliceable hazelnut product. The formulation for one particular embodiment is contained below in Table 6.

TABLE 6
Percentage by Weight of Ingredients added in Hazelnut
Slice Formulation According to an Embodiment

| Ingredient | Weight Percent |
|---|---|
| Hazel Nut Paste | ~56.0 |
| Pea Protein Concentrate | 8.0% |
| Mono & di-glyceride blend | 8.0% |
| Cocoa Butter | 8.0% |
| Water | 3.68% |
| Sugar | 14.0% |
| Transglutaminase Enzyme | 1% |
| Leithin | 1% |
| Gellan gum | 0.32% |

TABLE 7
Percentage Ranges by Weight of Ingredients added in
Hazel Nut Paste According to an Embodiment

| Ingredient | Minimum % | Maximum % |
|---|---|---|
| Hazel Nut Paste | 45 | 80 |
| Pea Protein Concentrate | 2 | 20 |
| Mono & di-glyceride blend | 0.20 | 15 |
| Cocoa Butter | 0.20 | 10 |
| Transglutaminase Enzyme | 0.20 | 3 |
| Lecithin | 0 | 3 |
| Gellan gum | 0.02 | 2 |
| Sugar | 0 | 20 |
| Water | 0 | 6 |

More generally, satisfactory weight composition ranges for an embodiment of a sliceable hazelnut butter would be one prepared within the constituent ranges of Table 7. In connection with this particular embodiment, a satisfactory weight composition would be, for example, 45 to 80 weight percent hazelnut paste, 2 to 20 weight percent pea protein concentrate, 0.2 to 15 weight percent mono & di-glyceride blend, 0.2 to 15 weight percent cocoa butter, 0 to 20 weight percent sugar, 0.2 to 3 weight percent transglutaminase enzyme, 0 to 3 weight percent lecithin, and 0.02 to 2 weight percent gellan gum, and 0 to 6 weight percent water.

Although the present communication may include alterations to the application or claims, or characterizations of claim scope or referenced art, the Applicant does not concede in this application that previously pending claims are not patentable over the cited references. Rather, any alterations or characterizations are being made to facilitate expeditious prosecution of this application.

Applicant reserves the right to pursue at a later date any previously pending or other broader or narrower claims that capture any subject matter supported by the present disclosure, including subject matter found to be specifically disclaimed herein or by any prior prosecution.

Accordingly, reviewers of this or any parent, child or related prosecution history shall not reasonably infer that the Applicant has made any disclaimers or disavowals of any subject matter supported by the present application.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Terms of approximation (e.g., “about”, “substantially”, “approximately”, etc.) should be interpreted according to their ordinary and customary meanings as used in the relevant art unless indicated otherwise. Absent a specific definition and absent ordinary and customary usage in the relevant art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A composition comprising 72-95 weight percent nut paste, 0.20 to 3 weight percent TG, 0.2 to 10 weight percent mono- & di-glycerides, and 0.02 to 1 weight percent gum.

2. The composition according to claim 1, wherein said nut paste is selected from the group consisting of peanut butter, cashew paste, and almond paste.

3. The composition according to claim 1, wherein said nut paste is peanut butter.

4. A method for producing individually wrapped slices of a hazel nut product comprising the steps of:
supplying a wrapping film;
delivering into said wrapping film a composition comprising 45-80 weight percent hazelnut paste, 2 to 20 weight percent pea protein concentrate, 0.2 to 15 weight percent mono- & di-glyceride blend, 0.02 to 3 weight percent TG, 0.2 to 15 weight percent cocoa butter, and 0.2 to 2 weight percent gum;
flattening said composition in said wrapping film;
forming individual segments of said composition;
individually sealing said individual segments of said composition in said wrapping film.

5. The composition according to claim 4, further comprising less than 3 weight percent lecithin.

6. The composition according to claim 4, wherein said gum is gellan gum.

7. The composition according to claim 4, further comprising less than 6% by weight of water.

8. The composition according to claim 4, further comprising less than 20% by weight of sugar.

9. A composition comprising 45-80 weight percent hazelnut paste, 2 to 20 weight percent pea protein concentrate, 0.2 to 15 weight percent mono- & di-glyceride blend, 0.02 to 3 weight percent TG, 0.2 to 15 weight percent cocoa butter, and 0.2 to 2 weight percent gum.

10. The composition according to claim 9, further comprising less than 3 weight percent lecithin.

11. The composition according to claim 9, wherein said gum is gellan gum.

12. The composition according to claim 9, further comprising less than 6% by weight of water.

13. The composition according to claim 9, further comprising less than 20% by weight of sugar.
